(19) United States
(12) Patent Application Publication
(10) Pub. No.: US 2010/0121469 A1
(43) Pub. Date: May 13, 2010

(54) MULTIFUNCTIONAL VOLLEYBALL SCORE SHEET GENERATOR

(76) Inventors: Debora A. Keller, Cleves, OH (US); Michael J. Gutzwiller, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 12/616,517

(22) Filed: Nov. 11, 2009

Related U.S. Application Data
(60) Provisional application No. 61/113,304, filed on Nov. 11, 2008.

(51) Int. Cl. G06F 19/00; A63B 71/06

(52) U.S. Cl. 700/92; 700/91

(57) ABSTRACT

Embodiments of the invention provide a method, apparatus, and program product to manage a volleyball match. In some embodiments, the method comprises displaying a set interface operable for a user to record at least one action associated with a volleyball set. The method further includes automatically storing information associated with the at least one action in response to user interaction with the set interface to record the at least one action. Furthermore, the method includes generating a scoresheet that includes the stored information, wherein the scoresheet is based upon a scoresheet template selected from a plurality of scoresheet templates.

This application claims the benefit of U.S. Patent Application Ser. No. 61/113,304, filed on Nov. 11, 2008, which is incorporated herein by reference in its entirety.

### FIELD OF THE INVENTION

The present invention relates to managing information for a volleyball match.

### BACKGROUND OF THE INVENTION

The game of volleyball has a complex scoring system. Not only are points scored for a miss, but points are often taken away from teams for invalid lineups, penalties, or improper substitutions. Additionally, the rules and scoring typically change depending on a particular league or level of play. For example, in the traditional scoring schemes, a point is awarded for defensive misses only; however, some leagues use rally scoring where a point is scored for both offensive and defensive misses.

During a conventional volleyball match, the players enter a court for play while a first official is positioned on a platform at the net and along the outside of the court sideline. A second official is typically positioned on the floor outside the court at the net and on the opposite side from the first official. Among other duties, the second official aids in administering substitutions and also with scoring duties. For example, the second referee often verifies the score sheet during timeouts and at the end of the games of the match. An officials' table is also often positioned outside the court sideline and near the second referee. Several officials may be seated at the officials' table, including a scorer, a scorer's assistant, a libero tracker, and a timer. The scorer is primarily charged with recording actions, such as the points scored, substitutions, timeouts, and penalties during the games of the match. The scorer's assistant is primarily responsible for updating a scoreboard to display the correct scores for the teams, the officials, and the spectators. The libero tracker primarily monitors the actions of a libero, which is a special defensive player with limited allowable actions. The timer is the official time keeper for the match including the prematch warm-up, time between sets, and/or timeouts, if applicable.

Since scoring is accomplished manually, the accuracy of the score sheet is often dependent on the level of skill and/or the attention provided by the scorer. Thus, problems often arise when an inexperienced or unqualified person is acting as the scorer. These problems can range from merely the readability of the score sheet to the accuracy of the score itself. Many leagues depend on volunteers to fill the scorer, scorer's assistant, libero tracker and timer roles. In many cases it is difficult to find enough qualified individuals to fill these roles.

Inaccuracies can also result from the inexperience or inattentiveness of the scorer's assistant. That is, while the score sheet may be completely accurate, the score reported on the scoreboard may include mistakes. Unfortunately, even unintended mistakes may bring about ill-mannered actions and words from participants and/or spectators, which decrease the level of fun for all of those involved.

Consequently, there is a continuing need to improve the accuracy by which the score for a volleyball match is kept as well as to reduce the manpower required to accurately keep that score. Additionally there is a need to aid inexperienced scorers, etc. in keeping accurate and complete scoresheets.

### SUMMARY OF THE INVENTION

Embodiments of the invention address the drawbacks of the prior art and provide a method, apparatus, and program product to manage a volleyball match. In some embodiments, the method comprises displaying a set interface operable for a user to record at least one action associated with the volleyball match. The method further includes automatically storing information associated with the at least one action in response to user interaction with the match interface to record the at least one action. Furthermore, the method includes generating a scoresheet that includes the stored information, wherein the scoresheet is based upon a scoresheet template selected from a plurality of scoresheet templates.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a diagrammatic illustration of a hardware and software environment for an apparatus configured to manage a volleyball tournament, match, and/or set consistent with embodiments of the invention;

FIG. 2 is a diagrammatic illustration of an application of the apparatus of FIG. 1;

FIG. 3 is a diagrammatic illustration of a database of the apparatus of FIG. 1;

FIG. 4 is an illustration of a rules screen operable to define rules for a tournament, match, and/or set consistent with embodiments of the invention;

FIG. 5 is an illustration of a match screen operable to receive information about a match and/or set consistent with embodiments of the invention;

FIG. 6A is an illustration of a set screen operable to receive information about a lineup for each team of a set, as well as record actions performed during the set, consistent with embodiments of the invention;

FIG. 6B is an illustration of the set screen of FIG. 6A in which the lineup for each team has been specified;

FIG. 7 is an illustration of a lineup screen operable to receive information from a user to specify the lineup for each team involved in a set consistent with embodiments of the invention;

FIG. 8 is an illustration of a penalty screen operable to receive information about a penalty assessed to a team consistent with embodiments of the invention;

FIG. 9 is an illustration of a player penalty screen operable to receive information about a penalty assessed to a player consistent with embodiments of the invention;

FIG. 10 is an illustration of a scoresheet screen operable to display a scoresheet consistent with embodiments of the invention;

FIG. 11 is an illustration of a libero screen operable to display information associated with the use of a libero consistent with embodiments of the invention;

FIG. 12 is an illustration of a statistics screen operable to display information about statistics associated with players of a team consistent with embodiments of the invention;

FIG. 13 is an illustration of a score screen operable to display on an output device consistent with embodiments of the invention;

FIG. 14 is a flowchart illustrating a sequence of operations executable by the computing system of FIG. 1 to track and manage a volleyball tournament, match, and/or set;

FIG. 15 is a flowchart illustrating a sequence of operations executable by the computing system of FIG. 1 to determine whether to increment the score of a team;

FIG. 16 is a flowchart illustrating a sequence of operations executable by the computing system of FIG. 1 to track timeouts used by a team;

FIG. 17 is a flowchart illustrating a sequence of operations executable by the computing system of FIG. 1 to track substitutions made by a team;

FIG. 18 is a flowchart illustrating a sequence of operations executable by the computing system of FIG. 1 to determine and manage a penalty for a team; and

FIG. 19 is a flowchart illustrating a sequence of operations executable by the computing system of FIG. 1 to determine the end of a match and/or set.

It should be understood that the appended drawings are not necessarily to scale, presenting a somewhat simplified representation of various features illustrative of the basic principles of embodiments of the invention. The specific design features of embodiments of the invention as disclosed herein, including, for example, specific dimensions, orientations, locations, and shapes of various illustrated components, as well as specific sequences of operations (e.g., including concurrent and/or sequential operations), will be determined in part by the particular intended application and use environment. Certain features of the illustrated embodiments may have been enlarged or distorted relative to others to facilitate visualization and clear understanding.

### DETAILED DESCRIPTION

### Hardware and Software Environment

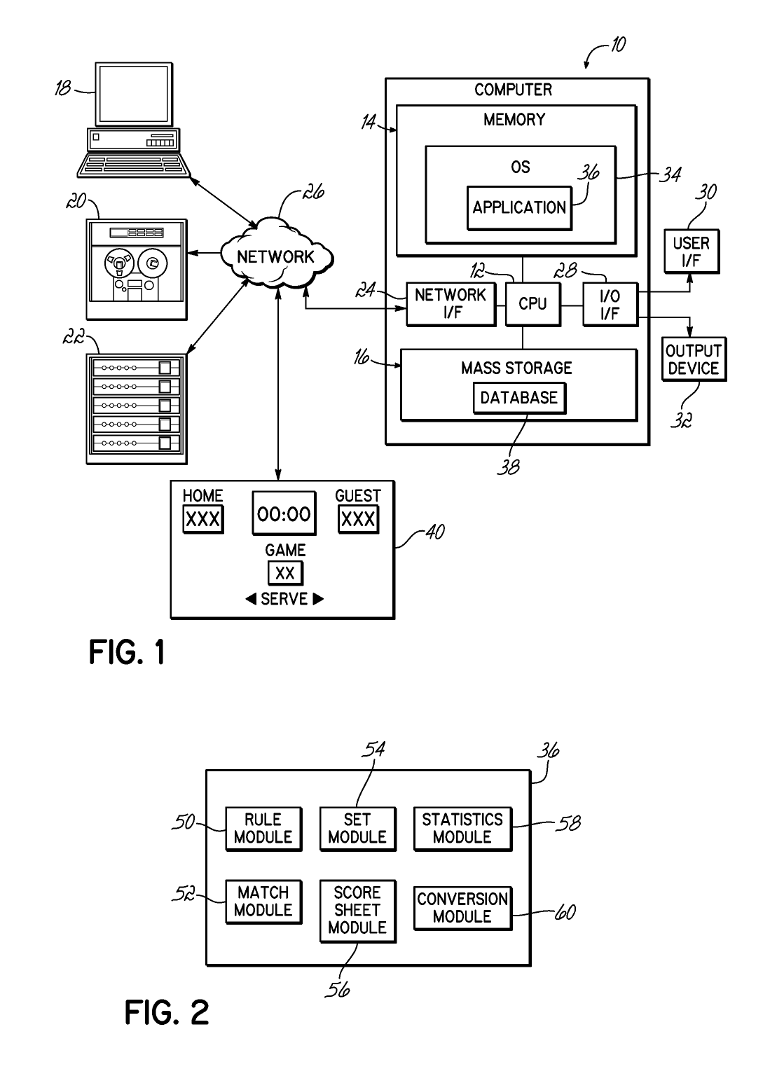

Turning to the drawings, wherein like numbers denote like parts throughout the several views, FIG. 1 is a diagrammatic illustration of a hardware and software environment for an apparatus 10 configured to determine and analyze information associated with a volleyball set, match, and/or tournament consistent with embodiments of the invention. Apparatus 10, in specific embodiments, is a computer, computer system, computing device, server, disk array, or programmable device such as a multi-user computer, a single-user computer, a handheld computing device, a networked device (including a computer in a cluster configuration), a mobile telecommunications device, a video game console (or other gaming system), etc. Apparatus 10 may be referred to as “computing apparatus,” but will be referred to herein as “computing system.”

The computing system 10 includes at least one central processing unit (“CPU”) 12 coupled to a memory 14. Each CPU 12 is typically implemented in hardware using circuit logic disposed on one or more physical integrated circuit devices or chips. Each CPU 12 may be one or more microprocessors, micro-controllers, field programmable gate arrays, or ASICs, while memory 14 may include random access memory (RAM), dynamic random access memory (DRAM), static random access memory (SRAM), flash memory, and/or another digital storage medium, and also typically implemented using circuit logic disposed on one or more physical integrated circuit devices, or chips. As such, memory 14 may be considered to include memory storage physically located elsewhere in the computing system 10, e.g., any cache memory in the at least one CPU 12, as well as any storage capacity used as a virtual memory, e.g., as stored on a mass storage device 16, another computing system 18, a network storage device 20 (e.g., a tape drive), or another network device 22 (hereinafter, a “server” 22) coupled to computing system 10 through at least one network interface 24 (illustrated as, and hereinafter, “network I/F” 24) by way of at least one network 26. It will be appreciated that the at least one network 26 may include at least one private communications network (e.g., such as an intranet) and/or at least one public communications network (e.g., such as the Internet). Similarly to the computing system 10, computing system 18 or server 22, in specific embodiments, is a computer, computer system, computing device, server, disk array, or programmable device such as a multi-user computer, a single-user computer, a handheld computing device, a networked device (including a computer in a cluster configuration), a mobile telecommunications device, a video game console (or other gaming system), etc.

The computing system 10 is coupled to at least one peripheral device through an input/output device interface 28 (illustrated as, and hereinafter, “I/O I/F” 28). In particular, the computing system 10 receives data from a user through at least one user interface 30 (including, for example, a keyboard, mouse, a microphone, and/or other user interface) and/or outputs data to the user through at least one output device 32 (including, for example, at least one display, speakers, a printer, and/or another output device). Moreover, in some embodiments, the I/O I/F 28 communicates with a device that is operative as a user interface 30 and output device 32 in combination, such as a touch screen display (not shown).

The computing system 10 is typically under the control of an operating system 34 and executes or otherwise relies upon various computer software applications, sequences of operations, components, programs, files, objects, modules, etc., consistent with embodiments of the invention. In specific embodiments, the computing system 10 executes or otherwise relies on an application 36 to determine and analyze information associated with a volleyball set, match, and/or tournament consistent with embodiments of the invention. In specific embodiments, the computing system 10 is configured with a database 38 to store data about rules, rosters, scoresheet templates, and/or other data associated with the tournament, match, and/or set consistent with embodiments of the invention.

In addition to various peripheral devices, the computing system 10 may be configured to control a scoreboard 40, such as a scoreboard typically used for athletic contests. As such, and in some embodiments, the computing system 10 is configured to couple with the scoreboard 40 through the network 26, while in alternative embodiments the computing system 10 is configured to couple with the scoreboard 40 through the I/O I/F 28 (connection through the I/O I/F 28 not shown).

FIG. 2 is a diagrammatic illustration of a plurality of applications, sequences of operations, components, programs, files, objects, modules, etc. (each of which is referred to as a “module” for simplicity), that may be included in the application 36 of FIG. 1. Specifically, FIG. 2 illustrates that the application 36 includes a rules module 50, a match module 52, a set module 54, a scoresheet module 56, a statistics module 58, and/or a conversion module 60. In some embodiments, the rules module 50 is configured to provide an interface for a user to input rules associated with a particular tournament, set, and/or match, while the match module 52 is configured to provide an interface to input a roster for at least one team as well as identifying information about the tournament, match, set, and/or other information associated therewith. The set module 54, on the other hand, is configured to provide an interface for the user to maintain the score for a match and/or set, as well as to configure lineups of teams, assign penalty points, and otherwise assist in officiating a particular set.

In some embodiments, the set module 54 is further configured to provide a second interface to display scores of a match and/or set to persons other than the user, and in specific embodiments the set module 54 is configured to interface with a output device 32 or scoreboard 40 accordingly. In some embodiments, the scoresheet module 56 is configured to provide an interface illustrating at least one of a plurality of different types of scoresheets containing match and/or set information, while the statistics module 58 is configured to automatically determine statistics associated with a match and/or set then provide an interface illustrating such. The conversion module 60, on the other hand, may be used to convert data associated with a tournament, match, and/or set to a format suitable for independent storage or printing, such as the portable document format (e.g., “.pdf” format) created by Adobe Systems, Inc., of Mountain View, Calif.

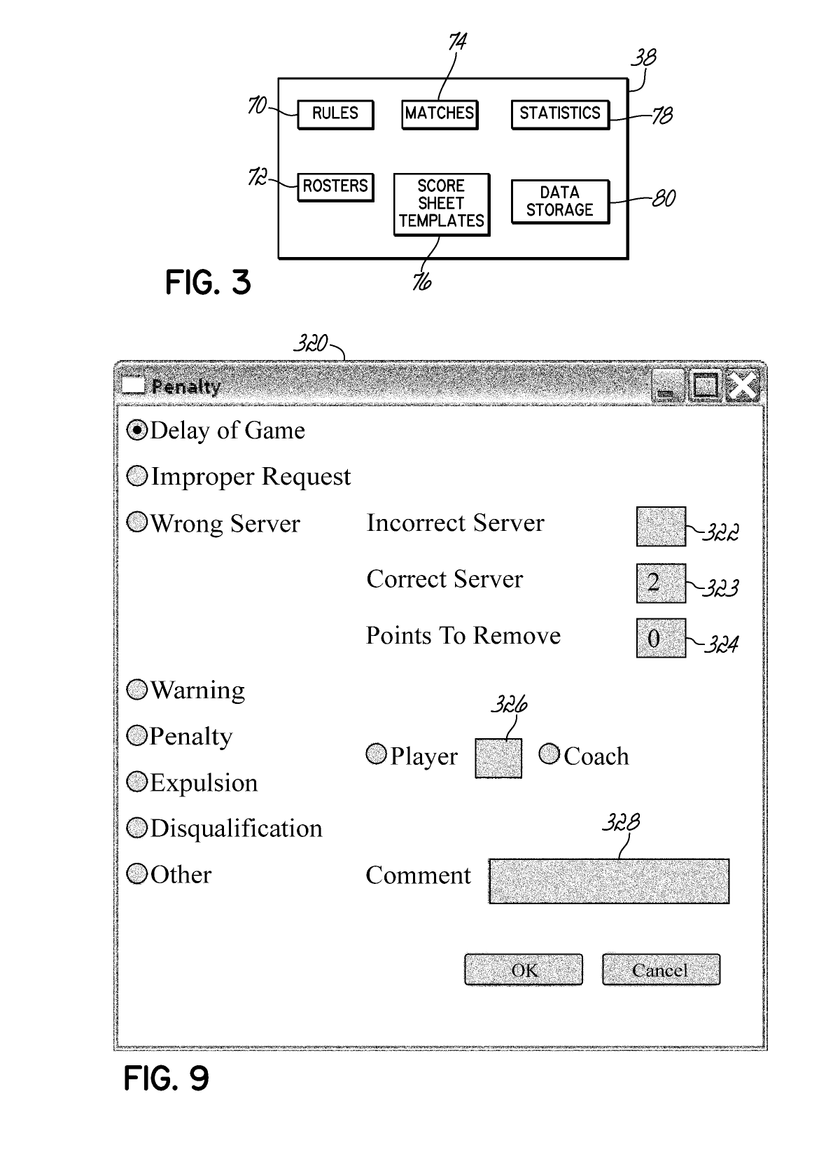

FIG. 3 is a diagrammatic illustration of a plurality of data structures that may be included in the database 38 of FIG. 1. Specifically, FIG. 3 illustrates that the database 38 includes a rules data structure 70, a rosters data structure 72, a matches data structure 74, a scoresheet templates data structure 76, a statistics data structure 78, and/or a data storage data structure 80. In some embodiments, the rules data structure 70 is configured to store rules associated with various types of organizations, while the rosters data structure 72 is configured to store rosters associated with teams competing in a league, tournament, match, and/or set. The matches data structure 74, on the other hand, is configured to store data associated with matches, including teams, rules, scoring events, and/or other data associated therewith. In some embodiments, the scoresheet templates data structure 76 is configured to store scoresheet templates, including National Federation of State High School Associations (“NFHS”) style scoresheet templates, National Association of Intercollegiate Athletics (“NAIA”) style scoresheet templates, National Collegiate Athletic Association (“NCAA”) style scoresheet templates, U.S.A. Volleyball (“USAV”) style scoresheet templates, Fédération Internationale de Volleyball (“FIVB”) style scoresheet templates, and/or additional scoresheet templates as may be used to score volleyball tournaments, matches, and/or sets. The statistics data structure 78 may be configured to store statistics associated with leagues, tournaments, matches, sets, teams, and/or players, while the data storage data structure 80 is configured to store other data that may be utilized by the application 36.

With reference to the rules data structure 70, a variety of pre-configured rules may be loaded with the installation of the application 36. In some embodiments, a variety of pre-configured scoresheet templates are also loaded with the pre-configured rules, including a NFHS template, an FIVB template, a USAV template, and/or additional templates. Thus, in some embodiments, the pre-configured rules define default and more specific rules for a tournament, match, and/or set. Table 1 is an example of a variety of pre-configured rules, including specific pre-configured rules defined by a plurality of governing bodies for volleyball, such as the FIVB, NFHS, and USAV, as well as commonly accepted default, instructional, and tournament rules.

TABLE 1
Pre-Configured Rules

| Name of | | | | | | |
|---|---|---|---|---|---|---|
| Rule Set: | Default | FIVB | NFHS | USAV | Instructional | Tournament |
| Match Rules: | | | | | | |
| Sets Per | 3 | 5 | 5 | 5 | 3 | 3 |
| Match | | | | | | |
| Set Winner | Best of N | Best of N | Best of N | Best of N | Play All Sets | Best of N |
| Points per Set | 25 | 25 | 25 | 25 | 25 | 25 |
| Points in | 15 | 15 | 15 | 15 | 25 | 15 |
| Deciding Set | | | | | | |
| Deciding Set | Not Capped | Not Capped | Not Capped | Not Capped | Capped | Capped |
| Points | | | | | | |
| Deciding Set | | | | | 30 | 20 |
| Point Cap | | | | | | |
| Team | 60 seconds | 30 | 60 | 30 | 60 | 30 |
| Timeout | | | | | | |
| Length | | | | | | |
| Official | 30 seconds | 30 | 30 | 30 | 30 | 30 |
| Timeout | | | | | | |
| Length | | | | | | |
| Set Play: | | | | | | |
| Service | 6 | 6 | 6 | 6 | 6 | 6 |
| Positions per | | | | | | |
| Team | | | | | | |
| Minimum | 6 | 6 | 6 | 6 | 5 | 6 |
| Players to | | | | | | |
| Start Set | | | | | | |
| Libero | Allowed | Allowed | Allowed | Allowed | Not Allowed | Allowed |
| Allowed | | | | | | |
| Libero | No Serve | No Serve | May Serve | No Serve | N/A | No Serve |
| Service | | | | | | |
| Maximum | 18 | 6 | 18 | 12 | 18 | 12 |
| Substitutions | | | | | | |
| Roster: | Required | Required | Required | Required | Required | Required |
| Instructional | | | | | | |
| Play: | | | | | | |
| Minimum | Not Required | Not Required | Not Required | Not Required | Required | Not Required |
| Playing Time | | | | | | |
| Minimum | N/A | N/A | N/A | N/A | 25 | N/A |
| Points Per | | | | | | |
| Match | | | | | | |
| Limit | No | No | No | No | Yes | No |
| Consecutive | | | | | | |
| Serves | | | | | | |
| Maximum | N/A | N/A | N/A | N/A | 4 | N/A |
| Serves | | | | | | |
| Scoresheet | NFHS | FIVB | NFHS | USAV | NFHS | USAV |
| Type: | | | | | | |

Thus, in some embodiments, the application 36 and database 38 are configured to be utilized to determine and analyze information associated with a volleyball set, match, and/or tournament consistent with embodiments of the invention. In specific embodiments, the application 36 is further configured to manage teams, players, scoring, penalties, peripherals (such as output displays or scoreboards 40), and/or scoresheets, as well as provide statistics associated therewith. In further specific embodiments, the application 36 is configured to selectively output scoresheets that include data gathered during the set, match, and/or tournament in at least one of a plurality of specific formats associated with volleyball scoring. Thus, embodiments of the invention are configured to interact with a user to manage multiple aspects of a volleyball contest.

For example, before the start of a game, the user, which may be a scorer, official, or judge, initiates the application 36 on the computing system 10, which may be at an official's table. As such, the user defines rules, team rosters, scoresheet templates, and sets up the match. The user then initiates the match, and more particularly a set thereof. During the set, the user may use the application to record inputs related to actions made during the match, such as a won rally (or miss), a substitution, a timeout, a penalty, the use of a libero, or other known and conventionally recorded events. The user may then navigate to a scoresheet to review actions recorded during the set and/or match.

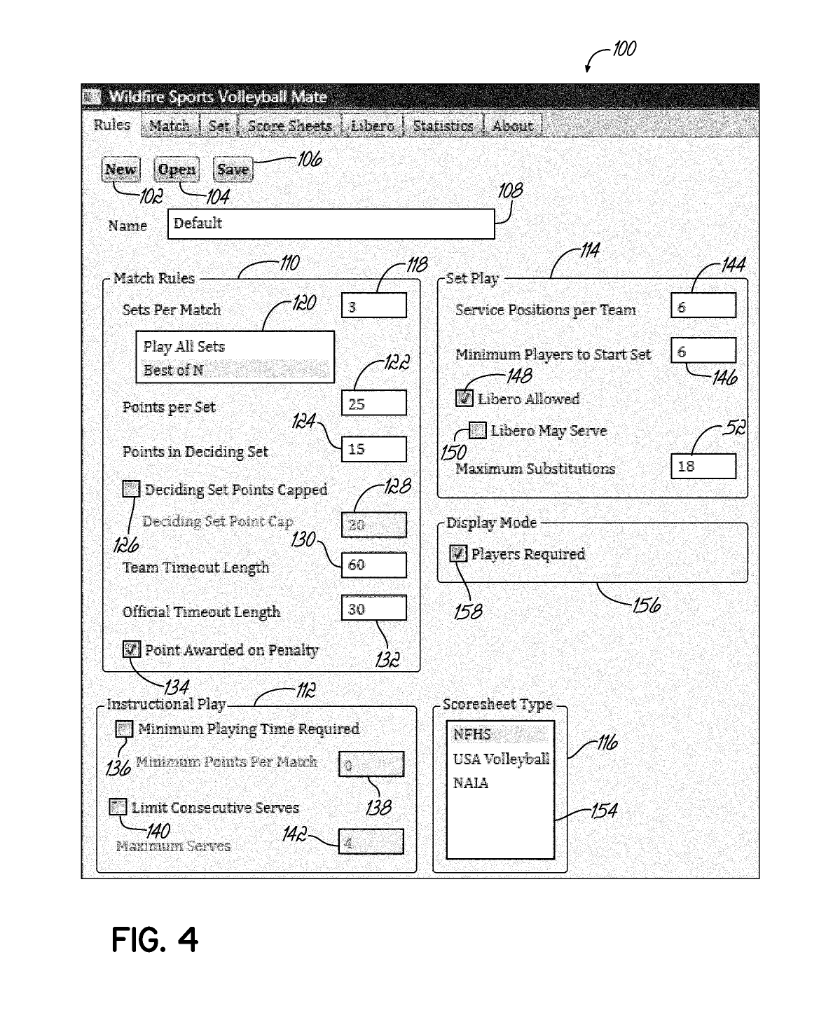

Consistent with embodiments of the invention, FIGS. 4-5, 6A-6B, and 7-13 illustrate a plurality of screens, windows, and/or interfaces (each referred to, for the sake of simplicity, as a “screen”) that may be provided by the application 36 (e.g., on at least one output device 32 of the computing system 10, through a web browser of the computing system 10, and/or through a web browser of a computing system configured across a network 26, such as computing system 18). In some embodiments, data for the screens 100, 160, 230, 300, 310, 320, 330, 350, 360, and/or 370 is generated by the application 36 and displayed by a web browser configured on the same computing system 10 as the application 36. In some embodiments, data for the screens of FIGS. 4-5, 6A-6B, and 7-13 is generated by the application 36 and displayed on the at least one output device 32. In alternative embodiments, data for the screens of FIGS. 4-5, 6A-6B, and 7-13 is generated by the application 36 and provided to a web browser of the computing system 18 through the network 26 (e.g., the computing system 10 is a networked computing system in communication with computing system 18, or a web server in communication with computing system 18). In further alternative embodiments, data for the screens of FIGS. 4-5, 6A-6B, and 7-13 is provided to a server (e.g., such as the server 22), that data being subsequently formatted and provided to the web browser of the computing system 18 from the server 22 across the network 26 (e.g., the computing system 10 provides data for the screens to the server 22, which may be a network server and/or a computing system in communication with computing system 18, and/or which may be a web server in communication with computing system 18).

FIG. 4 is an illustration of a rules screen 100 that may be displayed for a user to designate rules and a scoresheet style associated with a tournament, match, and/or set. From the rules screen 100, the user may define a new set of rules by selecting the “New” button 102, open a previously saved set of rules by selecting the “Open” button 104, and save a set of rules by selecting the “Save” button 106. In some embodiments, in response to selecting the “Open” button 104 a Windows® dialog is opened for the user to select a rules file previously saved in the database 38. As illustrated in FIG. 4, a name text entry box 108 allows the user to specify, or change, the name of a set of rules.

In some embodiments, the set of rules includes match rules that the user can specify in a match rules component 110, instructional play rules that the user can specify in an instructional play component 112, set play rules that the user can specify in a set play component 114, and which scoresheet template to use in a scoresheet component 116. In the match rules component 110, the user can specify the sets per match in a sets entry box 118, as well as select whether to play all sets or allow a “Best of N” match in a sets selection box 120. The user can also specify the points per set and the points in a deciding set in a respective points per set entry box 122 and points in deciding set entry box 124. The user can also select whether the deciding set points are capped by selecting the deciding set points checkbox 126. If the deciding set points checkbox 126 is selected, the user can specify the deciding set points cap in the deciding set points cap entry box 128. In some embodiments, the user can specify the timeout lengths for a team as well as the timeout lengths for officials in a respective team timeout length entry box 130 and official timeout length entry box 132. Finally, in the match rules component 110, the user can specify whether a point can be awarded on a penalty by selecting the penalty point checkbox 134.

In some leagues, tournaments, matches, and/or sets, it may be advantageous to allow all players a chance to play and/or prevent any particular player from monopolizing serving time. Thus, the application 36 can track the minimum playing time for each player as well as limit the consecutive serves by a player. As such, in the instructional play component 112, the user can specify whether a minimum playing time for a player is required by selecting the minimum play time checkbox 136. In response to selecting the minimum play time checkbox 136, the user can specify the minimum points per match that a player must be present in the court in a minimum points entry box 138. Also in the instructional play component 112, the user can specify a limit to consecutive serves for a player by selecting the limit consecutive serves checkbox 140. In response to selecting the limit consecutive serves checkbox 140, the user can specify the maximum number of consecutive serves that a player may serve in the maximum serves entry box 142. In alternative embodiments, the minimum playing time required could be based on the actual amount of time a player is in the court and/or the number of serves that player has played.

With respect to the set play component 114, the user can specify rules for each set. In some embodiments, the user can specify the service positions per team and the minimum players to start a set through a respective service positions per team entry box 144 and a minimum players to start entry box 146. The user can also specify whether a libero can be used in a set by selecting the libero allowed checkbox 148. In response to selecting the libero allowed checkbox 148, the user can also specify whether the libero is allowed to serve by selecting the libero may serve checkbox 150. Finally, in the set play component 114, the user can specify the maximum amount of substitutions allowed per team in the maximum substitutions entry box 152.

With respect to the scoresheet component 116, the user can select a scoresheet type to use by selecting any of the listed scoresheets in the scoresheet selection box 154. In some embodiments, the rules screen 100 includes a display mode component 156 in which the user can specify whether the application is to be used in a display mode only. In the display mode, the application 36 merely displays scores and does not record statistics about players, serves, and/or substitutions, and does not include the ability to import rosters of teams and/or use them. Rather, the display mode allows the application 36 to run without maintaining information about much other than the score of a set. In particular, the display mode is selected in response to the user deselecting a players required checkbox 158. Although not shown, it will be appreciated that the rules screen 100 may further include a drop down menu, selection box, or other user interface component that specifies whether scoring is based upon traditional rules, rally scoring, or another type of scoring or other rules that affect set play and/or scoring.

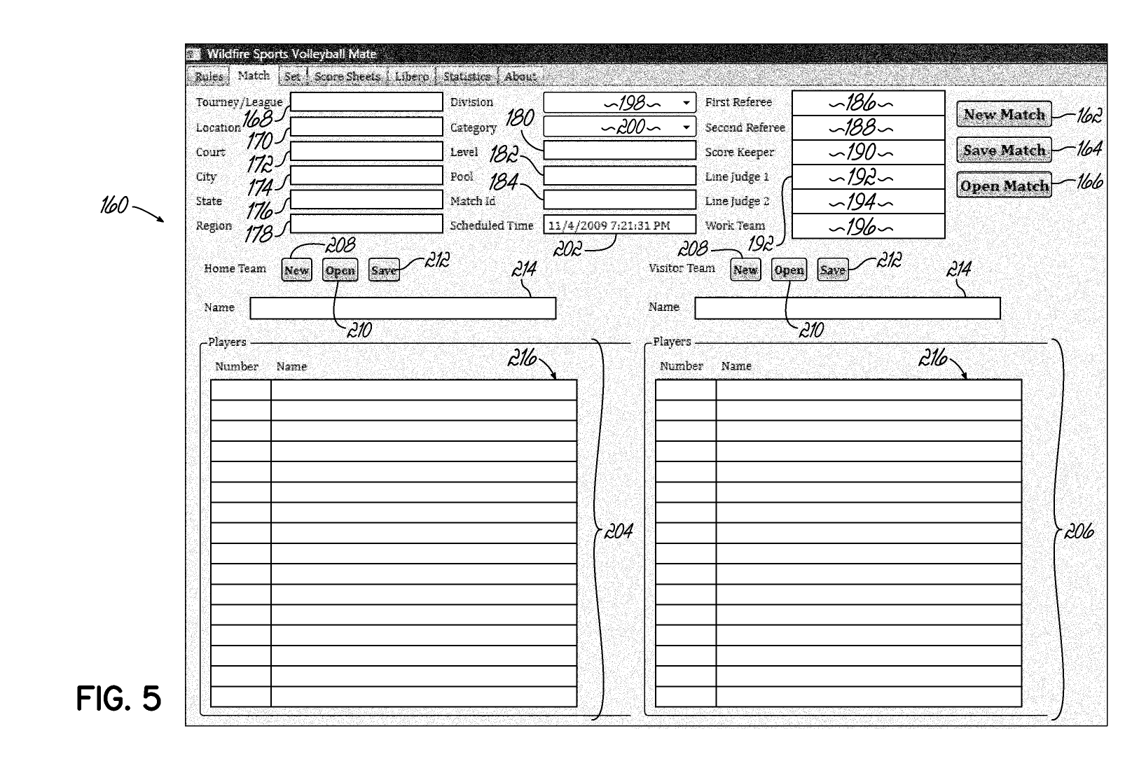

FIG. 5 is an illustration of a match screen 160 that may be displayed for the user to designate information about a match and/or set, including a roster of each team to include in that match and/or set. From the match screen 160, the user may define a new match by selecting the “New Match” button 162, save a match by selecting the “Save Match” button 164, and open a previously saved match by selecting the “Open Match” button 166. In some embodiments, in response to selecting the “Open Match” button 166 a Windows® dialog is opened for the user to select a match file previously saved in the database 38 by either the user or automatically by the program.

In the match screen 160, the user can specify the tournament and/or league associated with the match, the location of the match, the court of the match, the city of the match, the state of the match, the region of the match, the level (e.g., instructional, grade school, high school, or college) of the match, the pool of the match, a unique identifier of the match, the first referee for the match, the second referee for the match, the score keeper for the match, the first line judge for the match, the second line judge for the match, and/or the work team for the match through a respective tournament/league entry box 168, location entry box 170, court entry box 172, city entry box 174, state entry box 176, region entry box 178, level entry box 180, pool entry box 182, match identifier entry box 184, first referee entry box 186, second referee entry box 188, score keeper entry box 190, first line judge entry box 192, second line judge entry box 194, and/or work team entry box 196. In addition, the user can select a division and/or a category to assign to the match by selecting an appropriate division and/or category from the respective division drop down menu 198 and/or category dropdown menu 200. The user can also specify a scheduled time for the match. In some embodiments, the scheduled time is entered by the user through the scheduled time entry box 202. In alternative embodiments, the scheduled time is entered by the user selecting the scheduled time entry box 202, at which point a calendar is provided to the user to select the date and time to schedule that match (not shown). In alternative embodiments additional information associated with a match may be presented to the user and/or saved in the match database module.

In addition to specifying information about a match, the match screen 160 provides an interface to specify the home and visitor teams, as well as their respective rosters. As such, the match screen 160 includes a home team component 204 and a visitor team component 206, each of which may be used to specify a respective team to include in a match. From the match screen 160, the user may define a new team by selecting the “New” button 208, open information about a previously saved team by selecting the “Open” button 210, and save a team by selecting the “Save” button 212. In some embodiments, in response to selecting the “Open” button 210 a Windows® dialog is opened for the user to select a team file previously saved in the database 38. As illustrated in FIG. 5, a name text entry box 214 allows the user to specify, or change, the name of a team. Each of the home team component 204 and visitor team component 206 also includes a player specification component 216 in which the user may specify numbers and names for each of the players of a team in respective entry boxes. Alternative embodiments may designate the teams as A and B instead of Home and Visitor.

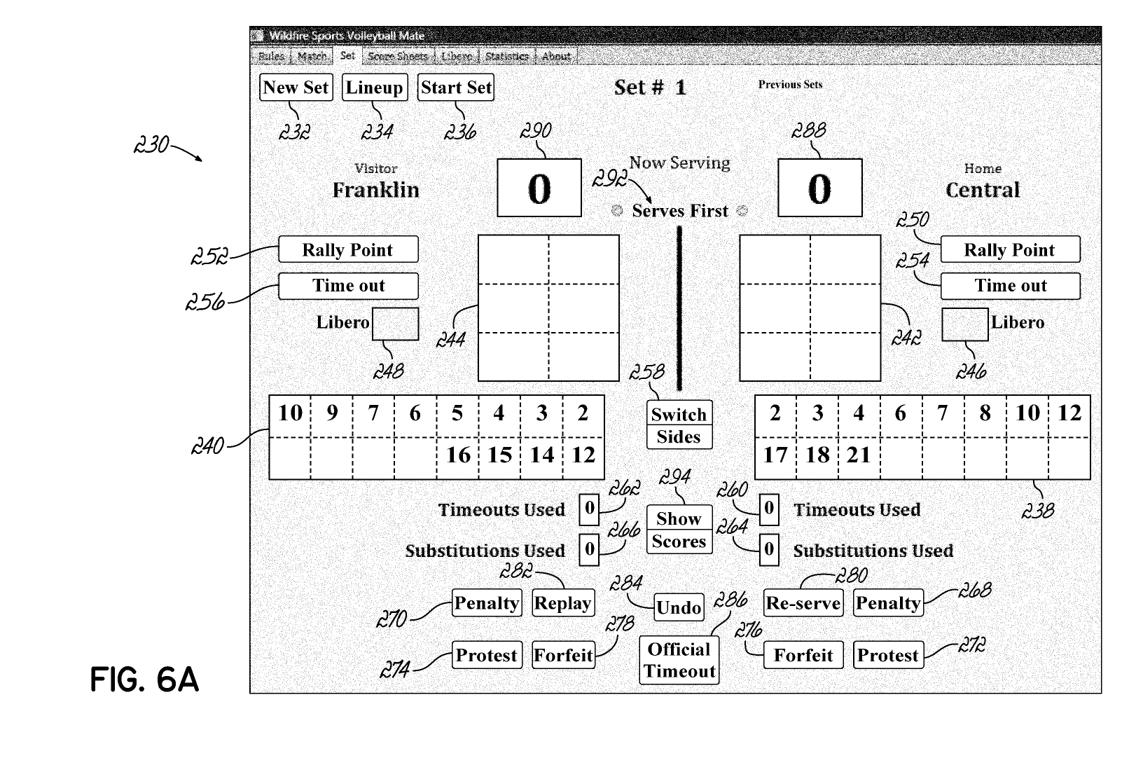

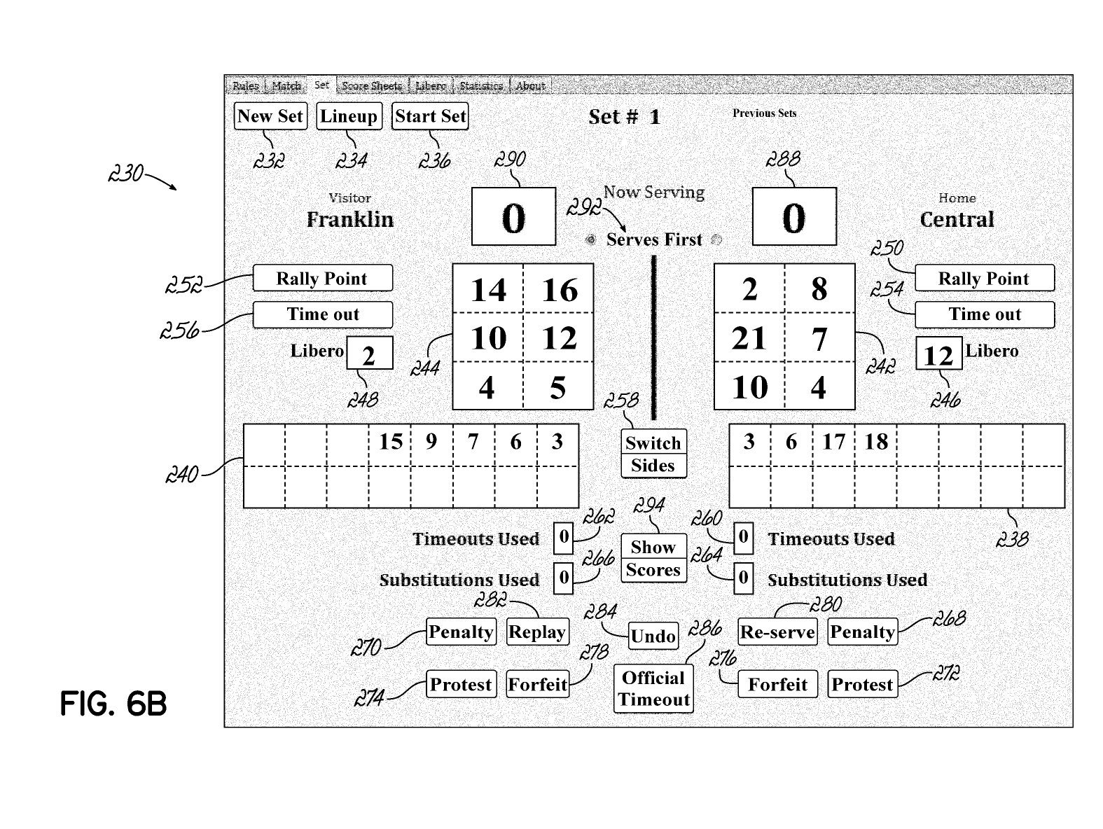

When the rules and rosters for a match have been specified, the user can specify the players and libero (if allowed) for a set, as well as record actions taken during that set. FIG. 6A is an illustration of a set screen 230 that may be displayed for the user to specify the lineup for each team of a set (e.g., their lineup in the court and a libero, if allowed), as well as record actions performed during that set. Specifically, the user can select a new set by selecting the “New Set” button 232, adjust the lineup of players in the court (e.g., specify which players are in which position, as well as which player is the libero) by selecting the “Lineup” button 234, and start the set by selecting the “Start Set” button 236. When a new set is selected, the set screen 230 is populated with the numbers of players from teams associated with that set in a respective home bench 238 and visitor bench 240. The user may then drag and drop players into their respective positions of the court 242 and/or 244 based upon a lineup card and/or based upon visual inspection of where those players initially position themselves within the court for the set. The user may also drag and drop libero players into respective libero boxes 246 and/or 248. For example, FIG. 6B is an illustration of the set screen 230 after players have been configured in their respective positions of the court 242 and/or 244 and/or libero boxes 246 and/or 248. Thus, FIG. 6B is an illustration of the set screen 230 after a lineup for each team has been entered.

Returning to FIG. 6A, the set screen 230 is configured to track the action of play, including which team serves, the points, the rotation of players through court positions, substitutions, the use of the liberos, timeouts, penalties, re-plays or re-serves, protests, and forfeits. As such, the user can select a respective “Rally Point” button 250 or 252 for a respective team to record and indicate which team won a point, as well as select a respective “Timeout” button 254 or 256 to record and indicate which team took a timeout. With respect to a point, the application 36 determines whether the point is allowed in response to the selection of the “Rally Point” button 250 or 252 based upon the rules specified for the set as well as which team is serving. This can include determining whether rally or traditional scoring is associated with the set and whether the point was scored by the offense or defense. In response to selection of the “Timeout” button 254 or 256, the application 36 determines whether the timeout is allowed, and if so increments a count of timeouts associated with the team that called for it. Moreover, the user may select a “Switch Sides” button 258 to switch the sides of the screen each team is displayed upon to better reflect the physical appearance of the players on the court and to eliminate confusion. This button 258 can also be selected when the teams switch sides of the net during the course of set and/or match play.

During the set, players move around the positions on their respective courts 242 and 244. In some embodiments, the positions of the players in their respective courts 242 and 244, and the substitution of the libero from the courts 242 and 244 if specified by the rules, is automatically performed by the application 36. For example, if the home team wins a point, the application 36 may determine whether to rotate the players of that team consistent with the rules and automatically substitute a libero out of the court 242, as well as automatically re-insert into the court 242 the player for whom the libero replaced. However, and also for example, if the home team serves and loses a point, the libero may be substituted in the court 242 for a player in the back row by the user (e.g., user drags the libero to a position in the back row of the court 242 that is already associated with a different player, or drags a player from the back row of the court 242 to the libero box 246).

The set screen 230 is configured with a timeouts used display box 260 and 262 for each respective team for the application 36 to display the timeouts taken by the teams and tracked by the application 36. The set screen 230 is configured with a timeout buttons 254 or 256 for each respective team for the user to select upon the team calling a timeout. As such, the application 36 increments the number in the timeouts used display box 260 or 262 by one each time a user selects a timeout button 254 or 256 associated with that team.

The set screen 230 is further configured with a substitutions used indicator box 264 and 266 for each respective team that indicates the substitutions made thereby (excluding replacements made by a libero). During the set, the application 36 tracks substitutions made by teams through user interaction with the benches 238 and/or 240 and respective courts 242 and/or 244 (e.g., a substitution is determined when a user drags a first a player from the benches 238 or 240 to a position in the respective courts 242 or 244 that is already associated with a second player and replaces the second player with the first player, or the user drags a first player from the court to a position on the bench already associated with a second player and replaces the first player with the second player). During the set, the application 36 is configured to determine whether substitutions are proper based upon rules for replacing players based positions played and number of substitutions used. During the set, the application 36 tracks replacements made by the libero through user interaction with the libero display 246 and/or 248 (e.g. libero replacement is determined when a user drags a libero player from the libero display 246 or 248 to a position in the respective courts 242 or 244 that is already associated with another player and replaces the second player with the libero. The application 36 determines if the replacement is legal based on rules on libero positioning).

The set screen 230 is further configured with respective “Penalty” buttons 268 and 270 for each team for the scorer to assign penalties to teams, respective “Protest” buttons 272 and 274 for each team for the scorer to log protests thereby, and respective “Forfeit” buttons 276 and 278 for each team for the scorer to record forfeits thereby. In some embodiments, the set screen 230 includes a “Re-serve” button 280 and a “Replay” button 282. A re-serve occurs when a server releases a ball for service then catches the ball or allows it to drop to the floor. A re-play, on the other hand, may be ordered when after a ball is served and before a point can be awarded, something occurs that requires a stoppage of play without awarding a point or service rotation. Moreover, the set screen 230 includes an “Undo” button 284 to undo an action taken by the user as well as an “Official Timeout” button 286 to provide timing of an official timeout. In response to the selection of the “Penalty” buttons 268 or 270, the user may specify whether the penalty results in a point to the opposing team, and/or whether the penalty results in points taken from the penalized team. In some embodiments, the user may specify whether to record infractions, such as a warnings, penalties, expulsions, disqualifications, as well as comments associated therewith.

The set screen 230 is also configured to illustrate the current score of the set. In particular, the set screen 230 is configured to illustrate the score for each team 288 and 290 as well as which team is serving 292. The user may also select the “Show Scores” button 294 to show the scores and possibly other selected information on a separate screen, such as an output device 32 and/or scoreboard 40.

In some embodiments, the application 36 is configured to track the number of points that each player has played, the time each player has played, and/or the number of serves each player has served. Advantageously, this assists the user in beginner level leagues by alerting them that the maximum number of serves for a particular player has been attained, and/or that the minimum number of points for a particular player has been attained. In some embodiments, where the application 36 tracks serves by a player, the application 36 may award a serve to an opposing team when a player has reached the maximum amount of serves. In alternative embodiments, where the application 36 tracks the amount of time a server has played, the application 36 may provide a play limit screen to the user indicating that a particular player has reached the maximum and/or minimum amount of playing time.

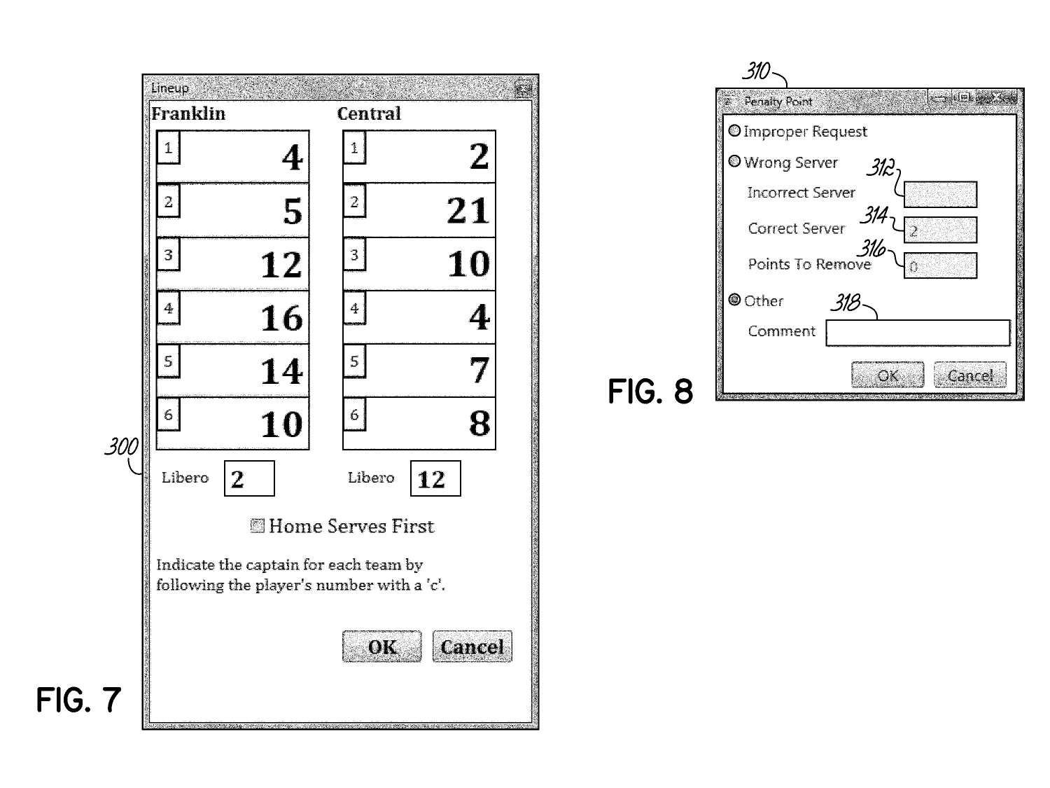

In addition to dragging and dropping players on the set screen 230, the user may specify which players are in which positions in the court through a lineup screen. FIG. 7 is an illustration of a lineup screen 300 that may be displayed for the user to specify the positions for each player in the court as well as libero for a set. Specifically, the lineup screen 300 is provided to the user in response to the user selecting the “Lineup” button 234 of the set screen of FIG. 6A and/or 6B. Returning to FIG. 7, the user may type the number of each player in their respective positions in the court, as well as indicate the captain for each team by following that player's number with a “c,” to configure the players in respective positions in the courts 242 and/or 244 of the set screen of FIG. 6A and/or 6B. Again returning to FIG. 7, the user may type the number of the libero into the respective libero portion of the lineup screen 300. The user may use the lineup by selecting an “OK” button or cancel the lineup and close the lineup screen 300 by selecting a “Cancel” button.

FIG. 8 is an illustration of a penalty screen 310 that may be displayed for the user to specify information about a penalty. Specifically, the penalty screen 310 is provided to the user in response to the user selecting the “Penalty” button 268 or 270 of the set screen 230 of FIG. 6A and/or 6B. Returning to FIG. 8, the user may specify that the penalty is for an improper request, wrong server or other reason. In the event that the penalty is for the wrong server, the user may also specify the incorrect server, the correct server, and/or the number of points to remove from the team associated with that incorrect server in the respective incorrect server entry box 312, correct server entry box 314, and/or points entry box 316. In the event that the penalty is for another reason, the user may specify that other reason in the comment entry box 318. The user may store the penalty information by selecting an “OK” button or cancel the penalty and close the penalty screen 310 by selecting a “Cancel” button.

FIG. 9 is an illustration of an alternative embodiment of a penalty screen 320 that may be displayed for the user to specify information about a penalty. Similarly to the penalty screen 310 of FIG. 8, the penalty screen 320 of FIG. 9 may be provided in response to the user selecting the “Penalty” button 268 or 270 of the set screen 230 of FIG. 6A and/or 6B. Returning to FIG. 9, the user may specify that the penalty is for a delay of game, improper request, wrong server, or other reason. In addition, the user may specify the severity of the penalty, such as that it is a warning, an actual penalty (in which the user may specify whether the penalty is for a player or a coach/bench), an expulsion, or a disqualification. In the event that the penalty is for the wrong server, the user may also specify the incorrect server, the correct server, and/or the number of points to remove from the team associated with that incorrect server in the respective incorrect server entry box 322, correct server entry box 323, and/or points entry box 324. In the event that the penalty is for a player, the user may also specify the player in a penalized player entry 326. In the event that the penalty is for another reason, the user may specify that other reason in the comment entry box 328. The user may store the penalty information by selecting an “OK” button or cancel the penalty and close the player penalty screen 320 by selecting a “Cancel” button.

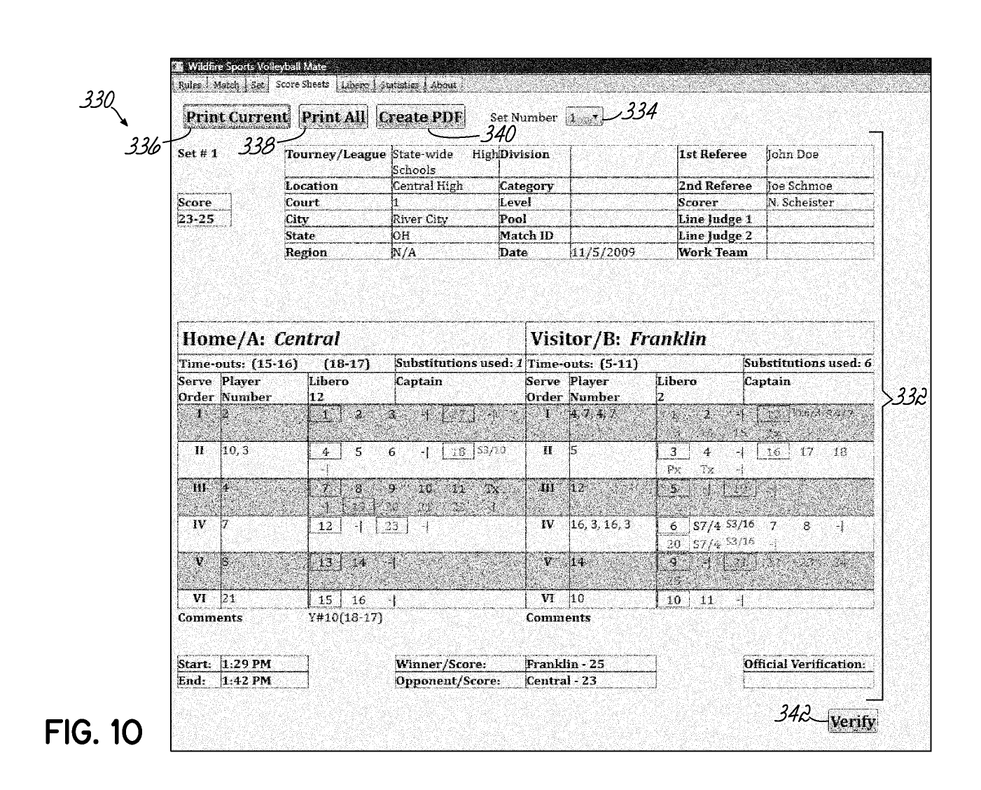

In some embodiments, the application 36 is configured to identify the end of a set as well as determine the end of a match. In particular, the application 36 determines the end of a set based upon the rules and score, while the application 36 determines the end of a match based upon the rules and the outcomes of the sets. When a match and/or set is over, and in some embodiments during the match and/or set, the application 36 is configured to create a scoresheet associated with that match and/or set in one of a plurality of different styles. FIG. 10 is an illustration of a scoresheet screen 330 that includes a scoresheet 332 in a template specified by the rules associated with that match and/or set. As illustrated in FIG. 10, the scoresheet 332 includes information from the match screen 160 of FIG. 5 as well as the action recorded during the match and/or set. In particular, the scoresheet 332 includes an indication of the score, teams, timeouts used, the players, their server order, and/or positions, the libero, the captain, how the game progressed (a progression of the scores and which players scored), the start and end times, as well as an identification of the official that verifies the results. In some embodiments, the scoresheet 332 is configured with enhanced readability by displaying actions after all positions have served (e.g., actions after the first six players for each team have served, whether those players were original starters in the set or were substituted in prior to the original starter serving) in a different color than other actions. In some embodiments, the scoresheet screen 330 allows a user to select which set of a match they wish to view a scoresheet 332 associated therewith. As such, the scoresheet screen 330 includes a set selection drop down menu 334 to select a set. The scoresheet screen 330 further includes a “Print Current” button 336 to print the scoresheet 332 associated with a selected set, a “Print All” button 338 to print the scoresheets 332 associated with each set of a match, and a “Create PDF” button 340 to convert the scoresheet 332 associated with a selected set to a .pdf format and save it in the database 38. It may be advantageous for an official, such as the scorer, to review and verify a scoresheet 332 prior to printing it. In this manner, the reviewer can correct errors and provide a record that the scoresheet is correct. Thus, and in some embodiments, the scoresheet screen 330 further includes a “Verify” button 342 that, upon selection, provides a verification screen for the user to enter their identification.

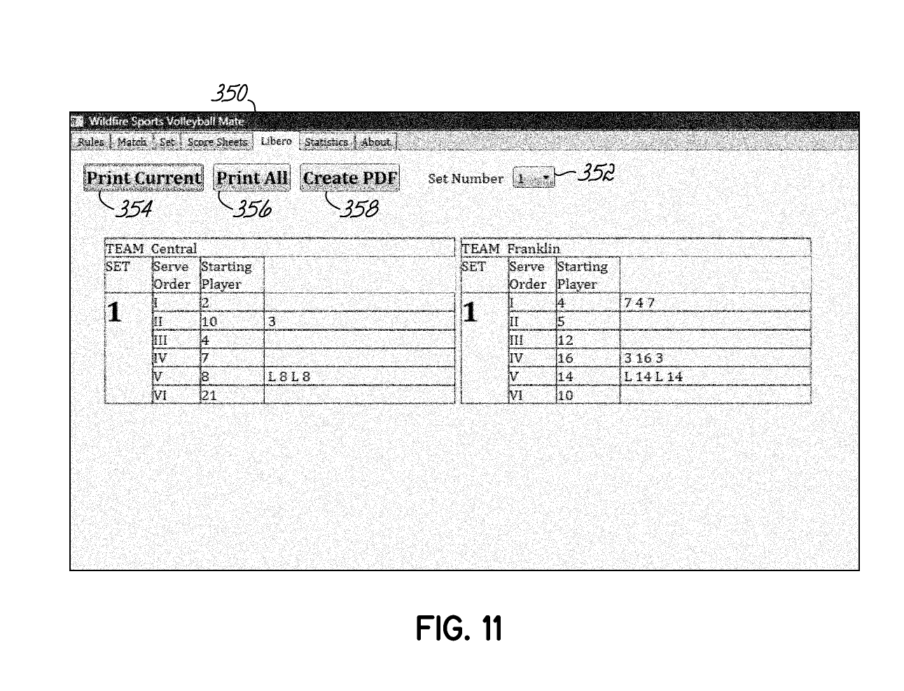

In some embodiments, the application 36 is further configured to track the utilization of liberos in a match and/or set. FIG. 11 is an illustration of a libero screen 350 that illustrates the utilization of liberos in a set. Similarly to the scoresheet screen 330 of FIG. 10, the libero screen 350 of FIG. 11 includes a set selection drop down menu 352 to select a set, a “Print Current” button 354 to print the information about the liberos associated with a selected set, a “Print All” button 338 to print the information about the liberos associated with each set of a match, and a “Create PDF” button 340 to convert the information about the liberos associated with a selected set to a .pdf format and save it in the database 38.

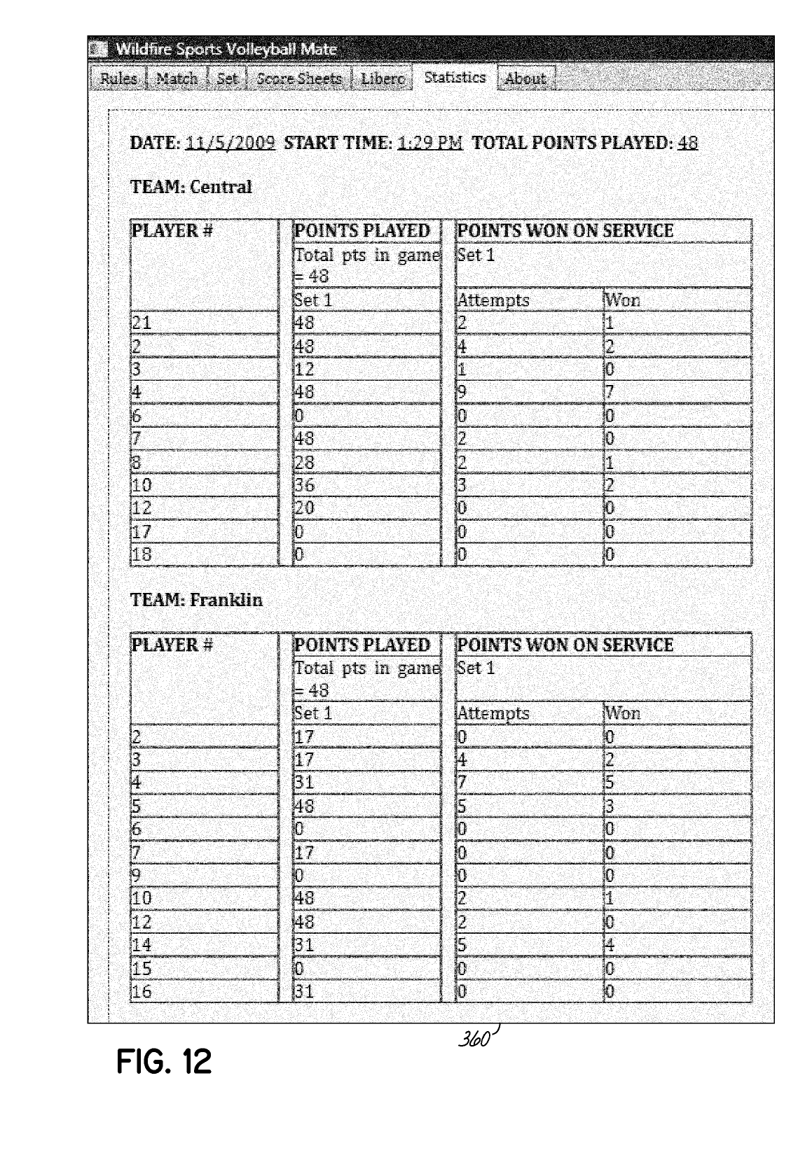

In some embodiments, the application 36 is configured to track statistics associated with the players, such as the points played by the players and points won during a player's term of service. FIG. 12 is an illustration of statistics screen 360 that illustrates statistics that may be tracked and displayed by the application 36. Specifically, the statistics screen 360 includes an indication of the players for a team as well as the total number of points in the set or match, the points each player played, the number of times each player served, and the amount of points won when the player was serving.

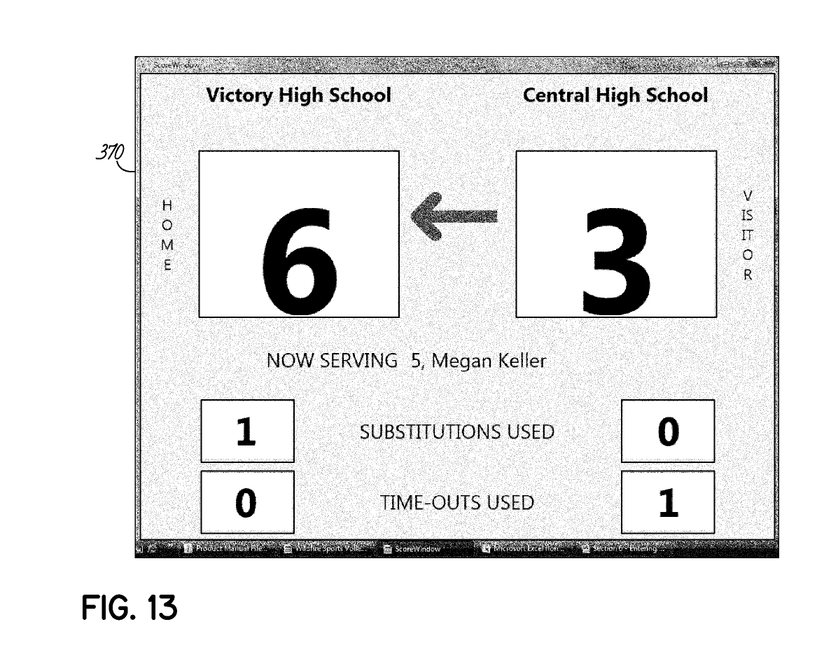

In some embodiments, the application 36 may be configured to display a score on an output device 32 and/or control a scoreboard 40 to display a score associated with a particular set. FIG. 13 is an illustration of a score screen 370 that may be displayed on an output device 32 in response to a user selecting the “Show Scores” button 294 on the set screen of FIG. 6A and/or 6B. As illustrated, this score screen 370 includes only basic information about the teams, such as an identification of the teams, an indication of which is the home team and which is the visiting team (or, alternatively, which is team A and which is team B), an indication of the serving team, the score, the player serving, substitutions used by each team, and timeouts used by each team. The score screen 370 is typically displayed on an output device 32 coupled to the computing system 10, and in particular an output device 32 that is not being used by the user to track and manage the actions in the set.

A person having ordinary skill in the art will recognize that the environments illustrated in FIGS. 1-3 are not intended to limit the scope of embodiments of the invention. In particular, the computing system 10, computing system 18, and/or server 22 may include more or fewer components consistent with alternative embodiments of the invention. Indeed, a person having skill in the art will recognize that other alternative hardware and/or software environments may be used without departing from the scope of the invention. For example, the application 36 may be configured with fewer or additional modules, while the database 38 may be configured with fewer or additional data structures. Additionally, a person having ordinary skill in the art will appreciate that the computing system 10 may include more or fewer applications disposed therein. As such, other alternative hardware and software environments may be used without departing from the scope of embodiments of the invention.

Moreover, a person having ordinary skill in the art will recognize that the environments illustrated in FIGS. 4-5, 6A, 6B, and 7-13, and in particular the user interface components thereof, are also not intended to limit the scope of embodiments of the invention. In particular, any of the screens 100, 160, 230, 300, 310, 320, 330, 350, 360, and/or 370 may include more or fewer user interface components consistent with alternative embodiments of the invention. For example, and with respect to the rules screen 100, in alternative embodiments, additional rules may be specified, including whether traditional or rally scoring is used, the maximum amount of timeouts for each team with respect to a specific tournament, match, and/or set, as well as whether re-plays or re-serves are permitted. In addition, one having ordinary skill in the art will appreciate that the rules screen 100 may include more or fewer components (e.g., buttons, selection boxes, actual selections, entry boxes, checkboxes) consistent with embodiments of the invention. For example, although three scoresheet types are illustrated in the scoresheet selection box 154, one having ordinary skill in the art will appreciate that the user may select from more or fewer scoresheet types, and thus from more or fewer scoresheet templates consistent with embodiments of the invention.

Furthermore, with respect to the penalty screen 310, this screen may include more or fewer components, including components that indicate whether to implement a change of service and/or provide points to the opposing team as well as the components to remove points from a team. The removal of a point may occur when a serving team scores a point while having an illegal player in the lineup. The removal of a point may also occur when an illegal action is performed by the player of a team. Similarly, it will be appreciated that the player penalty screen 320 may include more or fewer components, including whether the player received a red card or yellow card, whether a coach received a red card or yellow card, whether to remove points from the penalized player's team, whether to add points to the opposing team, and/or comments associated with the player penalty. In some embodiments, the application 36 increments a point of the opposing team for each red card and determines if there is a change of service based on whether the infracting team that served is associated with the red card.

Still furthermore, embodiments of the invention are configured to display additional screens as may be necessary. For example, in response to the application 36 determining that there are no more timeouts for a team that has called a timeout, the application 36 may provide a timeouts screen (not shown) that queries whether to apply a delay of game penalty. Also for example, in response to a team with a libero winning a rally to regain service, the application 36 may provide a libero notification screen (not shown) indicating that the libero was automatically replaced. Also for example, in response to determining that a set and/or match has ended, the application 36 may provide a respective end of set screen (not shown) and/or end of match screen (not shown) indicating that the respective end of the set and/or end of the match has been reached. Also for example, in response to a user selecting the “Verify” button 342 of the scoresheet screen 330, the application 36 may provide a verifying screen (not shown) in which an official may enter an identifier, such as their name or initials, to verify a scoresheet 332.

In some embodiments, a team is allowed to start a set without all service positions occupied on the court. For example, if the rules for a tournament, match, and/or set allow a set to start with less than the typical number of players, the application 36 may provide a ghost players screen (not shown) asking whether to insert “ghost” players into empty positions for that team. In this manner, when a ghost player rotates into a service position, the application 36 automatically grants a rally to the opponent to keep the set going, and may further provide a ghost server screen (not shown) indicating as such. In some embodiments, the application 36 is configured to track the substitutions by the teams in a match and/or set as well as track illegal substitutions. Thus, and for example, when a team substitutes a player but has already reached their substitution limit and/or a team substitutes a player who has already been playing in a different position the application 36 may provide an exceptional substitutions screen (not shown) that queries whether the substitution is an exceptional substitution or an injury substitution. If the substitution is not an exceptional substitution, the application 36 may provide an improper request screen (not shown) that queries whether an improper request penalty should be assessed. In some embodiments, the application 36 is configured to provide an indication of time remaining for timeouts. As such, the application 36 may display a countdown for a timeout on an output device 32 and/or scoreboard 40. For example, the application 36 may provide a timeout countdown screen (not shown) that indicates the time remaining for the timeout in seconds, tenths of a second, and/or hundredths of a second. The starting time for the countdown is dependent on whether the timeout is a team timeout or an official timeout.

Moreover, any of the screens 100, 160, 230, 300, 310, 320, 330, 350, 360, and/or 370 may include different interface components than those shown or described consistent with alternative embodiments of the invention. Specifically, any of the screens 100, 160, 230, 300, 310, 320, 330, 350, 360, and/or 370 may include different interface components than those shown or described but that also have consistent operation with those shown and described. For example, a drop down menu may be replaced with a selection box, a checkbox may be replaced with a selectable element, etc.

The routines executed to implement the embodiments of the invention, whether implemented as part of an operating system or a specific application, component, program, object, module or sequence of instructions executed by one or more computing systems will be referred to herein as a “sequence of operations,” a “program product,” or, more simply, “program code.” The program code typically comprises one or more instructions that are resident at various times in various memory and storage devices in a computing system, and that, when read and executed by one or more processors of the computing system, cause that computing system to perform the steps necessary to execute steps, elements, and/or blocks embodying the various aspects of the invention.

While the invention has and hereinafter will be described in the context of fully functioning computing systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical and tangible recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

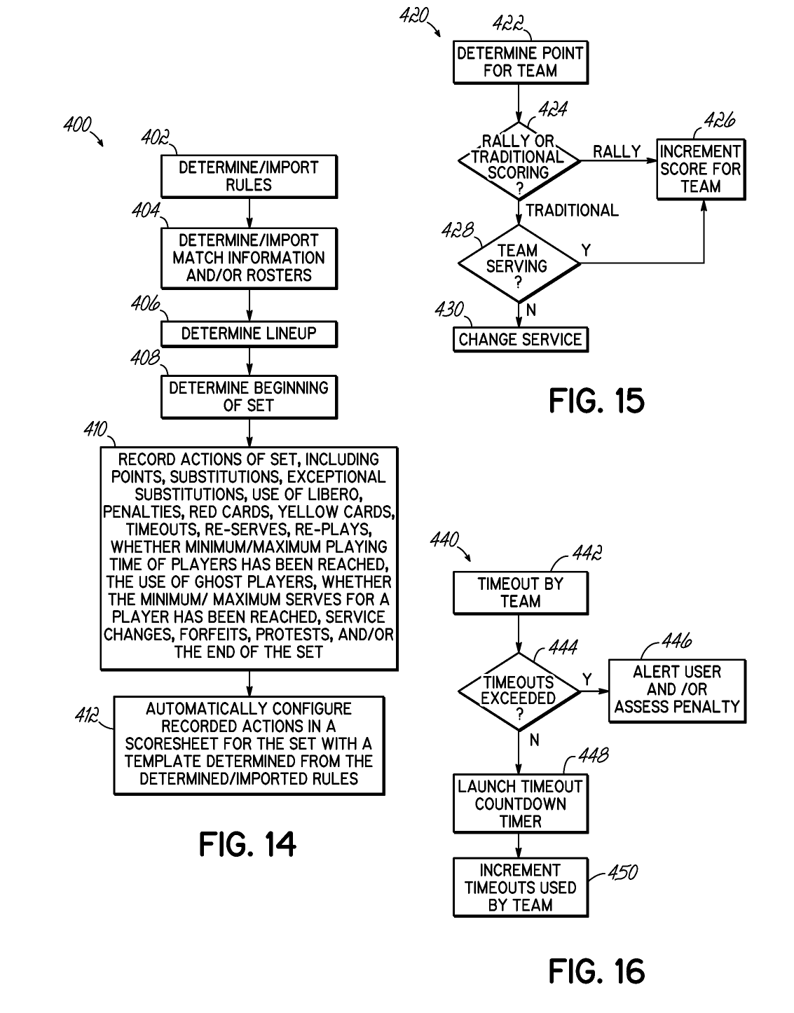

FIG. 14 is a flowchart 400 illustrating a sequence of operations for program code that may be executed to generally track and manage a volleyball tournament, match and/or set consistent with embodiments of the invention. In particular, rules associated with a volleyball tournament, match, and/or set are imported and/or determined (block 402) and match information and/or rosters are also imported and/or determined (block 404). At that point, a lineup for a match and/or set is determined (406) and the set is begun (block 408). At that point, the program code may record actions of the set, including points, substitutions, exceptional substitutions, the use of a libero in the set, penalties, red cards, yellow cards, timeouts, re-serves, re-plays, whether a minimum and/or maximum playing time for players has been reached, the use of ghost players, service changes, forfeits, protests, and/or the end of the set (block 410). The program code, after each action, configures the recorded actions in a scoresheet for the set with a template determined from the imported and/or determined rules (block 412).

FIG. 15 is a flowchart 420 illustrating a sequence of operations for program code that may be executed to determine whether to award a point to a team consistent with embodiments of the invention. In particular, the program code determines that a point has been awarded to a team, typically in response to a user selecting a “Rally Point” or “Point” button displayed by the program code and associated with the team (block 422). In response, the program code determines whether the set is associated with rally or traditional scoring (block 424). In response to determining that the set is associated with rally scoring (“Rally” branch of decision block 424) the score for the team is incremented (block 426). In response to determining that the set is associated with traditional scoring (“Traditional” branch of decision block 424), the program code determines whether the team was serving (block 428). In response to determining that the team was serving (“Yes” branch of decision block 428), the score for the team is incremented (block 430). In response to determining that the team was not serving (“No” branch of decision block 428), the service is changed from the opposing team to the team (block 430).

FIG. 16 is a flowchart 440 illustrating a sequence of operations for program code that may be executed to track timeouts of a team consistent with embodiments of the invention. The program code initially determines that a timeout is called by a team, typically in response to a user selecting a “Timeout” button displayed by the program code and associated with the team (block 442). In response, the program code determines whether the timeouts for the team have been exceeded (block 444). In response to determining that the timeouts for the team have been exceeded (“Yes” branch of decision block 444) the user is alerted and a penalty may be assessed to the team (block 446). In response to determining that the timeouts for the team have not been exceeded (“No” branch of decision block 444) a timeout countdown timer is launched and displayed (block 448). Specifically, the timer counts down for the time period specified for a team timeout indicated in the rules. The program code then increments a count of the timeouts used by the team (block 450).

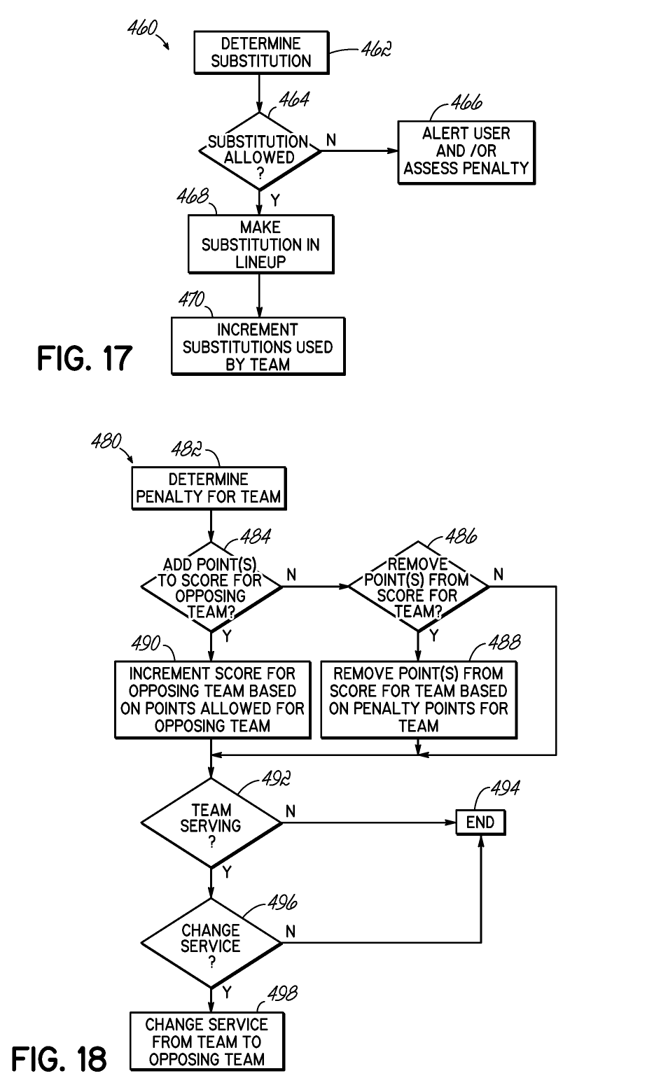

FIG. 17 is a flowchart 460 illustrating a sequence of operations for program code that may be executed to track substitutions made by a team consistent with embodiments of the invention. The program code initially determines that a substitution is made by a team, typically in response to a user substituting a player from a team bench to a position in the court already occupied by another player (block 462). In response, the program code determines whether the substitution is allowed (block 464). In particular, the program code determines whether the substitution is allowed with respect to substitutions that have already been used by a team, as well as with respect to whether an expelled or disqualified player is being substituted in, or the player being substituted in was previously replaced by an exceptional substitution. In response to determining that the substitution is not allowed (e.g., the substitution is illegal) (“No” branch of decision block 464), the user is alerted and a penalty may be assessed to the team (block 466). In response to determining that the substitution is allowed (“Yes” branch of decision block 464) the substitution is made in the lineup (block 468) and the program code increments a count of substitutions made by the team (block 470).

FIG. 18 is a flowchart 480 illustrating a sequence of operations for program code that may be executed to determine and manage a penalty for a team consistent with embodiments of the invention. The program code initially determines that a penalty has been assessed by a team, typically in response to a user specifying a penalty for the team (block 482). In response, it is determined whether at least one point is added to the score for the opposing team (block 484). When the penalty does not add points to the score for the opposing team (“No” branch of decision block 484), it is determined whether the penalty includes taking at least one point from the score for the team (block 486). When the penalty includes taking at least one point from the score for the team (“Yes” branch of decision block 486), the at least one point is taken from the score for the team based on the penalty points assessed to the team (block 488). Returning to block 484, when the penalty adds points to the score for the opposing team (“Yes” branch of decision block 484), the score for the opposing team is incremented based on the at least one point to add to the score for the opposing team (block 490).

In response to determining that the penalty does not include taking at least one point from the score for the team (“No” branch of decision block 486), taking at least one point from the score from the team (block 488), and/or incrementing the score for the opposing team (block 490), the program code determines whether the team assessed the penalty was serving (block 492). In response to determining that the team was not serving (“No” branch of decision block 492), the sequence of operations may end (block 494). In response to determining that the team was serving (“Yes” branch of decision block 492), it is determined whether the penalty includes changing the service from the team to the opposing team (block 496). When the penalty does not include changing the service from the team to the opposing team (“No” branch of decision block 496), the sequence of operations may end (block 494). When the penalty does include changing the service from the team to the opposing team (“Yes” branch of decision block 496), the service is changed from the team to the opposing team (block 498).

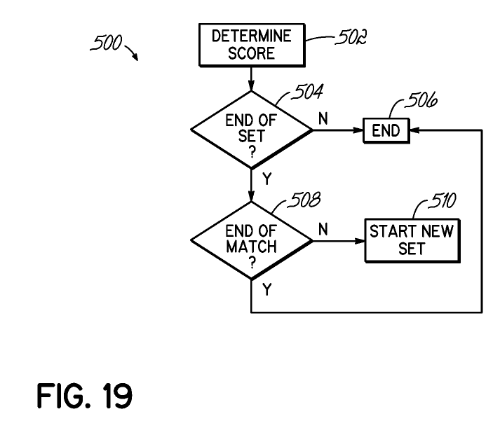

FIG. 19 is a flowchart 500 illustrating a sequence of operations for program code that may be executed to determine whether the end of a set and/or match has been reached consistent with embodiments of the invention. Initially, the program code determines the score of a set (block 502). In response, the program code determines whether the end of a set has been reached (block 504). In particular, the program code determines whether the end of a set has been reached with respect to the score and the rules. When the end of a set has not been reached (“No” branch of decision block 504), the sequence of operations may end (block 506). When the end of a set has been reached (“Yes” branch of decision block 504) the program code determines whether the end of the match has been reached (block 508). When the end of the match has not been reached (“No” branch of decision block 508), a new set is started (block 510). When the end of the match has been reached (“Yes” branch of decision block 508), the sequence of operations may end (block 506).

While the present invention has been illustrated by a description of the various embodiments, and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. In particular, a person having ordinary skill in the art will appreciate that any of the blocks of the above flowcharts may be deleted, augmented, made to be simultaneous with another, combined, or be otherwise altered in accordance with the principles of the embodiments of the invention. Accordingly, departures may be made from such details without departing from the spirit or scope of Applicants' general inventive concept.

Other modification will be apparent to one having ordinary skill in the art. Therefore, the invention lies in the claims herein appended.

1. A method of managing a volleyball match, comprising, with a computing system:
displaying a set interface operable for a user to record at least one action associated with a volleyball set;
in response to user interaction with the set interface to record the at least one action, automatically storing information associated with the at least one action; and
generating a scoresheet that includes the stored information, wherein the scoresheet is based upon a scoresheet template selected from a plurality of scoresheet templates.

2. The method of claim 1, further comprising:
determining a set of rules for the match.

3. The method of claim 2, wherein determining the set of rules includes:
importing a file that includes the set of rules.

4. The method of claim 2, wherein determining the set of rules includes:
determining the set of rules from user interaction with a rules interface operable for the user to define the set of rules.

5. The method of claim 1, further comprising:
determining at least one roster for at least one team associated with the match.

6. The method of claim 5, wherein determining at least one roster includes:
importing a file that includes the at least one roster.

7. The method of claim 5, wherein determining at least one roster includes:
determining the at least one roster from user interaction with a roster interface operable for the user to define the at least one roster.

8. The method of claim 1, further comprising:
displaying the scoresheet;

9. The method of claim 8, further comprising:
converting the displayed scoresheet into a digital file.

10. The method of claim 1, wherein the at least one action is a rally point, the method further comprising:
automatically determining, based upon a set of rules associated with the match, whether to increment a score of a team involved in the set that is associated with the rally point.

11. The method of claim 1, wherein the at least one action is a rally point, the method further comprising:
automatically determining, based upon a set of rules associated with the match, whether to change service to a first team involved in the set from a second team involved in the set, the first team being associated with the rally point.

12. The method of claim 1, wherein the at least one action is a substitution associated with a team involved in the set, the method further comprising:
automatically determining, based upon a set of rules associated with the match as well as a history of substitutions previously utilized by the team, whether the substitution is legal.

13. The method of claim 12, wherein the substitution is illegal, the method further comprising:
determining whether the substitution is an exceptional substitution.

14-30. (canceled)

31. An apparatus, comprising:
at least one processing unit; and
a memory containing program code, the program code configured to, when executed by the at least one processing unit, display a set interface operable for a user to record at least one action associated with a volleyball set, automatically store information associated with the at least one action in response to user interaction with the set interface to record the at least one action, and generate a scoresheet that includes the stored information, wherein the scoresheet is based upon a scoresheet template selected from a plurality of scoresheet templates.

32. A program product, comprising:
program code for managing a volleyball match, the program code configured to, when executed by at least one processing unit, display a set interface operable for a user to record at least one action associated with a volleyball set, automatically store information associated with the at least one action in response to user interaction with the set interface to record the at least one action, and generate a scoresheet that includes the stored information, wherein the scoresheet is based upon a scoresheet template selected from a plurality of scoresheet templates; and
a computer readable medium bearing the program code.
